(19) United States
(12) Patent Application Publication
(10) Pub. No.: US 2002/0070881 A1
(43) Pub. Date: Jun. 13, 2002

(54) User tracking application

(76) Inventors: Louis G. Marcarelli, Quincy, MA (US); Allan Tseng, Chelmsford, MA (US)

Correspondence Address: JOHN F. HAYDEN, Fish & Richardson P.C., 601 Thirteenth Street, NW, Washington, DC, 20005, US

(21) Appl. No.: 09/975,562

(22) Filed: Oct. 12, 2001

Related U.S. Application Data
(60) Provisional application No. 60/239,265, filed on Oct. 12, 2000.

(51) Int. Cl. G08G 1/123; G08B 23/00

(52) U.S. Cl. 340/988; 340/573.1; 340/825.36; 340/825.49

(57) ABSTRACT

A user tracking system includes a first unit and a second unit. The first unit includes a first radio transceiver and a first printed circuit board that includes microprocessor circuitry and modem circuitry. The second unit includes a second radio transceiver and an enclosure enclosing a GPS antenna, a GPS receiver, and a second printed circuit board comprising microprocessor circuitry and modem circuitry.

### CROSS REFERENCE TO RELATED APPLICATIONS

This application claims priority from provisional application No. 60/239,265, filed Oct. 12, 2000, which is incorporated by reference.

### TECHNICAL FIELD

This invention relates to a user tracking system, and more particularly to a user tracking system that is based on receiving data from one or more global positioning satellites (“GPS”).

### BACKGROUND

User tracking systems implementing GPS technology have been used for tracking people and vehicles. For example, automatic vehicle locator (“AVL”) systems may be used for fleet management and generally involve the use of portable phones and monthly communication fees. Typical AVL systems include two hardware devices on the vehicle: a global positioning antenna and an electronics component. The GPS antenna is permanently mounted on the outside of the vehicle. The electronics component is a rather large (5 inch×7 inch×2 inch) “electronics box” that contains the communications device, modems, and other required circuitry, and is permanently mounted in the vehicle.

There are three methods of communication used by most AVL systems: (1) digital radio; (2) satellite-based communications systems; and (3) portable-phone-based communications systems. These methods are used for wide area coverage and for dedicated channel transmission of the location and other information transmitted for fleet tracking or vehicle locating. Other product designs that are not intended for vehicle location are usually built into, or are a part of, a telephone-based design, but are either one-way devices (when there is no remote command capability) or manually operated by the user. These typically require service fees in one form or another.

### SUMMARY

In one general aspect, a user tracking system includes a first unit and a second unit. The first unit includes a first radio transceiver and a first printed circuit board that includes microprocessor circuitry and modem circuitry. The second unit includes a second radio transceiver and an enclosure enclosing a GPS antenna, a GPS receiver, and a second printed circuit board that includes microprocessor circuitry and modem circuitry.

Implementations of the user tracking system may include one or more of the following features. For example, the enclosure may have a volume that is less than approximately five cubic inches and/or a width that is less than two inches, a height that is less than two inches, and a depth that is less than one inch. The second printed circuit board may have dimensions of between approximately two inches by two inches and 1.5 inches by 1.5 inches. More particularly, the second printed circuit board may have dimensions of approximately 1.7 inches by 1.7 inches. The second printed circuit board may further include power management circuitry.

The second radio transceiver may include radio transceiver circuitry contained within the enclosure. The enclosure may further include an outer housing having a display screen.

The circuitry for the modem may be configured to convert data to a format that can be transmitted by the radio transceiver. The circuitry may be configured to convert data using one or more of audio frequency shift keying, digital tone multiple frequency, or MSK techniques.

The first unit may further include a microprocessor and a display, and the microprocessor may be configured to cause the display to display a position of the second unit. The software may be configured to display a position of the second unit on one or more of a map display or an arrow display. The second unit may be configured to transmit a signal that causes the first unit to activate a display procedure. The display procedure may include one or more of a light indicator and a noise indicator.

The second unit may be portably mounted in a vehicle and may be configured to receive a signal from the first unit that causes the second unit to alter a vehicle function. The vehicle function may include one or more of an ignition deactivation and a door lock or unlock. The second unit may be configured to transmit a signal that is receivable by the first unit and contains one or more of an identification code, an emergency signal, position data, and vehicle operating information. The vehicle operating information may include one or more of speed, fuel consumption, presence of a passenger, tire air pressure, and fare meter on or off.

In another general aspect, using a user tracking system includes providing a first unit, providing a second unit, creating a data packet, sending a first transmission including the data packet from the second unit, receiving the first transmission at the first unit, and displaying location information about the second unit. The first unit includes a first radio transceiver and a first printed circuit board that includes microprocessor circuitry and modem circuitry. The second unit includes a second radio transceiver and an enclosure enclosing a GPS antenna, a GPS receiver, and a second printed circuit board that includes microprocessor circuitry and modem circuitry.

Implementations of using the user tracking system may include one or more of the following features. For example, creating the data packet may include receiving GPS data from the GPS receiver, parsing and formatting the GPS data as a data packet in the microprocessor, and converting the data packet in the modem to one or more audio tones. Sending a first transmission may include having the second radio transceiver transmit the audio tones. Receiving the first transmission may include having the first radio transceiver receive the first transmission.

Displaying location information about the second unit may include converting the first transmission from one or more audio tones into a data packet, extracting the location information from the data packet, and using software to display the location information. The displayed location information may include one or more of a position on a map and position coordinates.

Using the user tracking system may further include sending a second transmission from the first unit, receiving the second transmission at the second unit, and causing the microprocessor circuitry in the second unit to take an action based on the received second transmission. The second transmission may include a data packet that may be created in the microprocessor and converted in the modem to one or more audio tones. The action may include one or more of continuously activating a transmission from the second unit and turning off a speaker of the second unit.

The enclosure may have a volume that is less than approximately five cubic inches and/or a width that is less than two inches, a height that is less than two inches, and a depth that is less than one inch. The second printed circuit board may have dimensions of between approximately two inches by two inches and 1.5 inches by 1.5 inches. More particularly, the second printed circuit board may have dimensions of approximately 1.7 inches by 1.7 inches. The second printed circuit board may further include power management circuitry.

In another general aspect, a GPS transceiver includes a printed circuit board that includes microprocessor circuitry, power management circuitry, and modem circuitry.

Implementations of the GPS transceiver may include one or more of the following features. For example, the second printed circuit board may have dimensions of between approximately two inches by two inches and 1.5 inches by 1.5 inches and, more particularly, of approximately 1.7 inches by 1.7 inches. The printed circuit board may be positioned within an enclosure and the enclosure may have a volume that is less than approximately five cubic inches and/or a width that is less than two inches, a height that is less than two inches, and a depth that is less than one inch. The enclosure may further include radio transceiver circuitry and/or a display screen that is configured to display location information. The GPS transceiver may further include a speaker, a microphone, and a push-to-talk button.

The displayed location information may be received by the GPS transceiver and/or the radio transceiver circuitry. The information received by the GPS transceiver may be converted to the display location information by the microprocessor circuitry. The displayed location information may be the location information of a second GPS transceiver.

The GPS transceiver may further include a calibration button that causes the microprocessor circuitry to convert the information received by the GPS transceiver to display location information and to display the location information on the display screen.

The user tracking system provides considerable advantages. For example, the cost of the user tracking system may be reduced through use of conventional voice channels. By being designed to work with existing two-way radio networks, the user tracking system can avoid monthly fees. Because of the specially configured circuitry, the system is enclosed in a small, portable enclosure or package. Specifically, the entire GPS with patch antenna, receiver with chip sets, such as, for example, SIRF II chip-sets made by SiRF Technologies, high-speed modem, and microcomputer is contained inside an approximately 2 inch×2.5 inch×1 inch enclosure. The system also can be operated with any radio transceiver at any frequency. The system is configured to be mounted to a vehicle or attached to a portable radio for portable use. The system also can include an emergency alert feature, is simple to set up and operate with plug and play capability, can be used with a portable base station, has integrated system software that is easy to use, and its operating license is included in the basic cost.

The user tracking system also has an advantageous product package configuration with the GPS antenna, the GPS receiver and all of the required electronics circuitry being fully integrated into one miniature package. Moreover, the user tracking system can be advantageously interfaced with existing communications methods. The user tracking system can be used as a stand along product or with an already existing computer aided dispatch (CAD) system. Thus the system can be sold in either a closed system configuration for small to medium size operations or in an open architecture mode interfaced to a CAD system and dedicated radio channel. This capability gives the system an advantageous level of flexibility at a hardware cost that is a fraction of conventional systems.

The details of one or more implementations of the user tracking system are set forth in the accompanying drawings and the description below. Other features and advantages will be apparent from the description, the drawings, and the claims.

### DESCRIPTION OF DRAWINGS

FIG. 1 is a plan view of a basic user tracking system.

FIG. 2 is a plan view of a remote tracking controller of the user tracking system of FIG. 1.

FIG. 3 is a flow chart of the transmission sequence for transmitting data from a remote unit of the user tracking system of FIG. 1.

FIG. 4 is a flow chart illustrating methods of initiating the transmission sequence from the remote unit.

FIG. 5 is a plan view of a base controller tracker of the user tracking system of FIG. 1.

FIG. 6 is a flow chart of the reception sequence of a base unit of the user tracking system of FIG. 1.

FIG. 7 is a plan view of the user tracking system applied to a taxi cab company.

FIG. 8 is a plan view of the user tracking system applied to a fleet management system.

FIG. 9 is a plan view of the user tracking system applied to a public safety vehicle environment.

FIG. 10 is a plan view of the user tracking system applied to a fire fighting battalion.

FIG. 11 is a plan view of the user tracking system applied to a shooting game.

FIG. 12 is a plan view of the user tracking system applied to a multi-person buddy system.

FIG. 13 is a plan view of an outer housing of a portable radio using a user tracking system.

FIG. 14 is a plan view of the inner components of the portable radio of FIG. 13.

FIG. 15 is a front view of a display screen of the portable radio of FIG. 13.

Like reference symbols in the various drawings indicate like elements.

### DETAILED DESCRIPTION

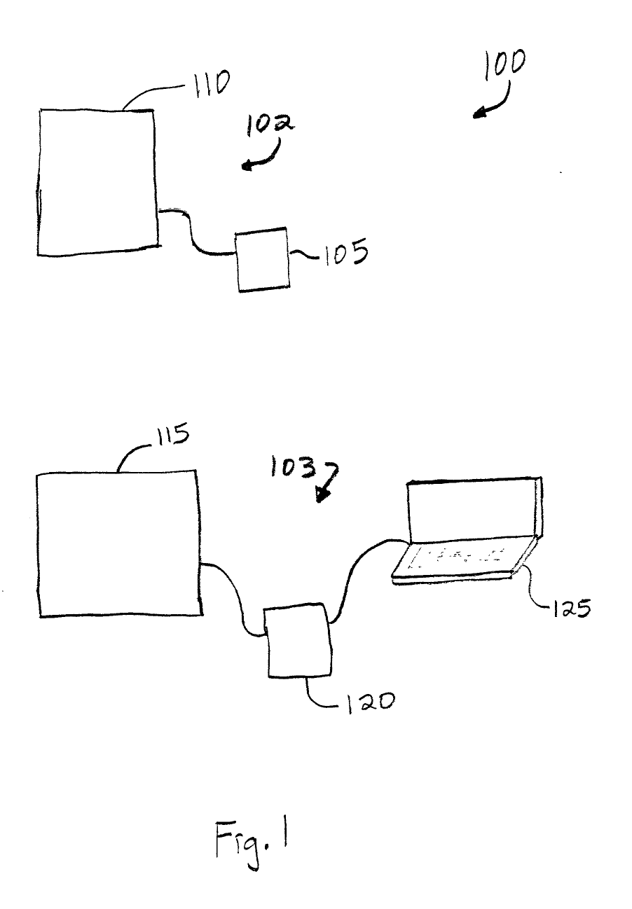

Referring to FIG. 1, a basic user tracking system 100 includes a remote unit 102 and a base unit 103. The user tracking system 100 can be used, for example, to locate a person or object in proximity to the remote unit. In general, the remote unit 102 obtains position data (i.e., latitude and longitude data) from a GPS system, encodes or converts that data and other data to a data format for radio transmission, such as audio tones, and transmits that data using conventional radio transmission technology. The data is transmitted by, for example, using a microphone, an emergency button, or based on a time sequence. The base unit 103 receives the encoded audio tones using conventional radio reception technology, decodes the audio tones, and displays the position of the remote unit, for example, on a map that is displayed on a computer display. In general, the radio transmissions of the user tracking system 100 can be made from a radio transmission device of any frequency, and/or by voice data, digital data, scrambled data, or cellular telephone transmission. The tracking system 100 transmits audio frequency signals over voice capable radio systems, may be used over a repeater radio system, and may have adjustable delay timing so it may be used with a trunking radio system. The base unit can be used to track the remote unit and automatically notify the remote unit if it moves outside of a pre-selected location, if it is too close or closer to a pre-selected location, of if it is moving too quickly or too slowly. The data is transmitted by the base station by, for example, using a microphone, an emergency button, or based on a time sequence. The base station also can be mobile or fixed, and may include a map display, an arrow display, lights, buzzers, or other indicators or displays to alert the operator's attention to a reception of information.

The remote unit 102 includes a remote tracking controller 105 and a radio transceiver 110. The radio transceiver may be a conventional two-way radio, such as a walkie-talkie, citizen's band radio, amateur or ham radio, or cellular telephone. The remote tracking controller 105 is connected to the radio transceiver 110 using a conventional cable that can be plugged into the external accessory connector or speaker/microphone jack of the radio. The base unit 103 includes a radio transceiver 115, base controller tracker 120, and a computer 125. The base unit may be powered, for example, by a conventional 110-115 volt AC power source. The base unit also may be configured to be portable and powered by a 12.0 volt DC power supply, such as a vehicle battery, or by any other conventional battery or power supply. A first end of a conventional cable is plugged into the external accessory connector or speaker/microphone jack of the radio transceiver 115 and a second end of the cable is connected to the base controller tracker 120. A second conventional cable connects the base controller tracker 120 to the computer 125.

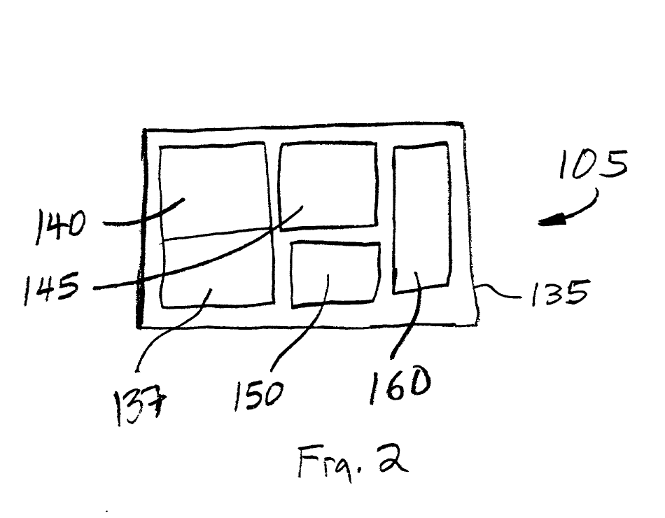

Referring to FIG. 2, the remote tracking unit includes an enclosure 135, a GPS antenna 137, a GPS receiver 140, a data conversion controller 145, a modem 150 that implements, for example, 1200 baud Audio Frequency Shift Keying (“AFSK”), and software 160 for the remote unit. The modem also can be implemented using digital tone multiple frequency (“DTMF”), MSK, or other modem techniques, including frequency shifting. The software 160 may be in the form of hardware and is configured to perform the necessary decoding and processing functions required to transfer and decode the GPS digital position data through the audio circuitry of a conventional two-way radio. The remote tracking unit 105 may be configured to be powered by a 12.0 volt DC power supply, such as a vehicle battery, or by any other conventional battery or power supply. The remote tracking unit also may be configured to be powered by a conventional 110-115 volt AC power source.

The data conversion controller 145 and the modem 150 can be implemented as a single, multi-layer printed circuit board (“PCB”). For example, the PCB can be fabricated using surface mount technology on either or both sides of the board. The PCB can be miniaturized to have dimensions of between approximately 2 inches by 2 inches and 1.5 inches by 1.5 inches, and more particularly, of approximately 1.7 inches by 1.7 inches.

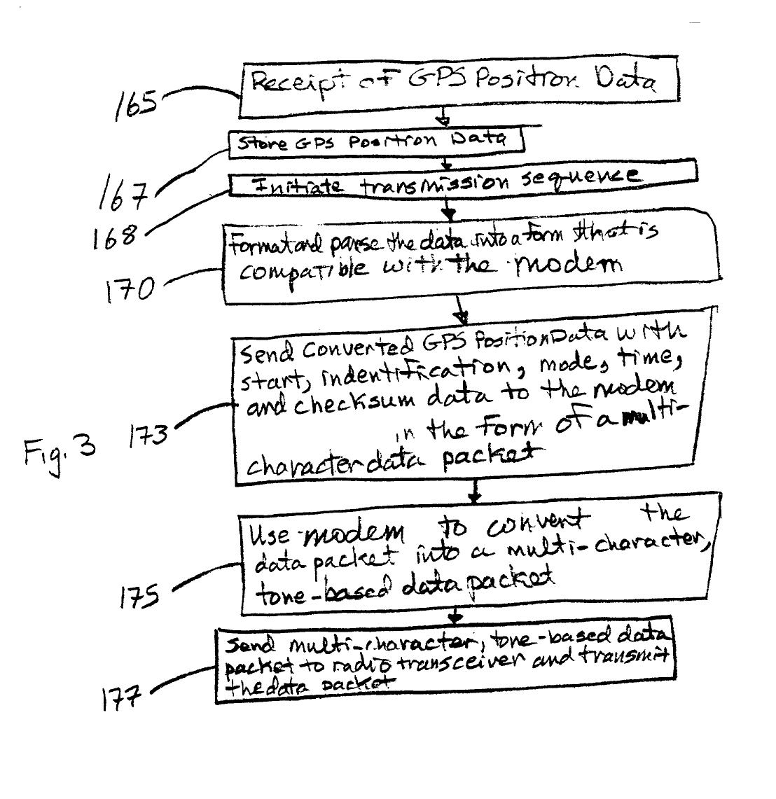

Referring also to FIG. 3, in particular, the remote tracking unit 105 continuously receives GPS position data through the GPS receiver 140 using techniques that are well known in the art (step 165). The GPS position data then is stored continuously or periodically in the data conversion controller 145 (step 167). A transmission sequence is initiated upon receipt of a signal or action (step 168), at which point the GPS position data is parsed and formatted into a character string that is compatible with the modem 150 (step 170). The GPS data together with other data that is sent to the modem, which includes start, identification, mode, time, and checksum, forms a data packet (step 173). The data packet can be in the form of, for example, a 27 character data packet that includes a start of message character, three characters that provide an identification of the remote unit, one character that provides the mode (e.g., clear all, acknowledge, microphone relay on, location request, emergency transmit or receive), four characters that provide the time of the transmission, seven characters that provide the latitudinal position data from the GPS signal, eight characters that provide the longitudinal position data from the GPS signal, and three characters for a check. The data packet also can be encoded into character strings or ASCII characters, or can be compressed using any known compression scheme. The modem 150 converts the data packet received from the data conversion controller 145 into a multi-character, tone-based data packet in the form of an audio tone or tones that can be transmitted through any radio frequency transceiver (step 175). The modem 150 sends the audio tones to the radio transceiver 110, which transmits the tones in a manner similar to other audio transmissions using conventional techniques that are well known in the art (step 177). The transmitted signal can be sent before, simultaneously with, or after the operator's audio transmission.

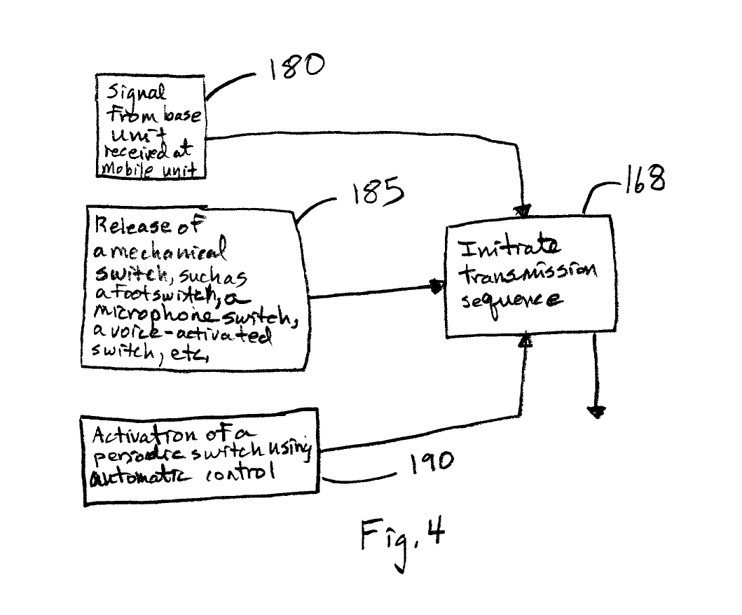

Referring to FIG. 4, the transmission sequence (step 168) that culminates in the transmission of the data packet from the radio transceiver 110 can be initiated in a number of ways. For example, as described below, the base unit 103 can contact the remote unit 102 and initiate the transmission of the data packets in the form of audio tones (step 180). The remote unit 102 can initiate the transmission automatically whenever the microphone is activated or released, a foot-activated emergency switch is activated, or a voice-activated switch is activated (step 185). The remote unit also can automatically initiate the transmission sequence on a periodic basis so that the base unit 103 will receive regular positioning updates (step 190). In each of these initiation methods, the base station will be regularly provided with the precise location of each user of a remote unit 102.

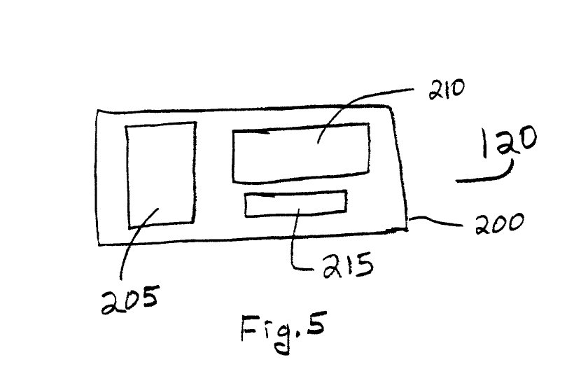

Referring to FIG. 5, the base controller tracker 120 includes an enclosure 200 and a modem 205 that can be operated in the manner described above with respect to modem 150, a data conversion controller 210, and software 215. Like the software 160 in the remote unit 105, the software 215 may be in the form of hardware, and is configured to perform the necessary decoding and processing functions required to receive and decode the GPS digital position data through the audio circuitry of a conventional two-way radio. Also like the remote tracking controller 105, the data conversion controller 210 and the modem 205 can be implemented as a single, multi-layer PCB.

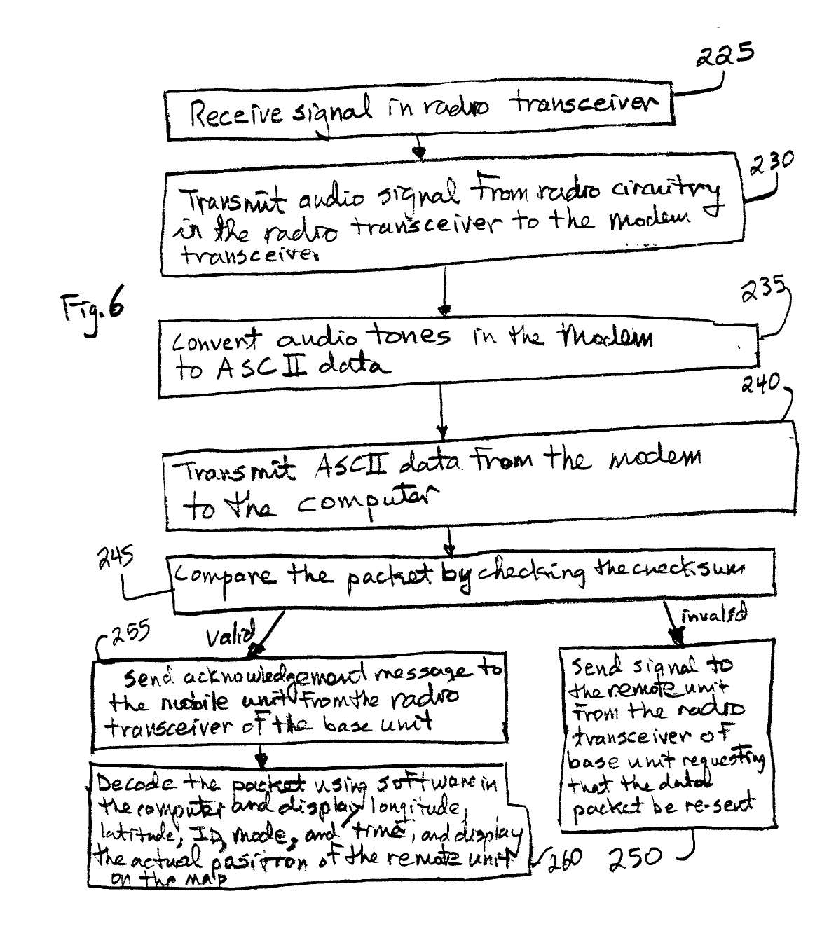

Referring to FIG. 6, the base unit 103 receives the transmitted signal from the remote unit's radio transceiver 110 in a manner similar to any other audio transmission from the operator of the remote unit. The transmitted signal can be sent before, simultaneously with, or after the operator's audio transmission. The signal is received by the radio transceiver 115 as an audio signal (step 225). The audio signal is transmitted from the circuitry of the radio transceiver 115 to the modem 205 (step 230). The modem 205 converts the audio signal from audio tones to ASCII data (step 235). The modem then transfers the ASCII data to the computer 125 (step 240). The computer has software that checks the packet of data in ASCII form by verifying the checksum data that were sent (245). If the data are not complete or are corrupted, the data are considered to be invalid and the computer software causes the radio transceiver 110 to send a signal to the radio transceiver 110 of the remote unit 102 (step 250). This instructs the remote unit to re-send its transmission. If the data are complete based on the checksum data, an acknowledgement message is sent by the radio transceiver 115 (step 255). This message can be initiated by software in the computer or hardware in the base controller tracker 120. The computer then decodes the data packet using software in the computer and displays the longitude, latitude, ID, mode, and time, and/or the actual position of the remote unit on a map (step 260).

The remote tracking controller 105 is configured to be contained within the relatively small enclosure 135. For example, the enclosure can be approximately 2.5×2.5×1.0 inches. The enclosure also can have a volume of approximately five cubic inches or less. The base tracking controller 120 can be approximately 3.6×4.4×6.9 inches. The ability to contain the controller within a relatively small enclosure is a result of the circuitry arrangement, especially the small size of the PCB used to implement the modem and the controller. Much of the circuitry is formed on a multi-layer, printed integrated circuit board. The GPS signal is passed through a driver which amplifies the GPS signal and passes the amplified signal to the tracking controller 120.

The PCB is composed of three major units: the GPS receiver and antenna, the controller, such as a micro-controller, and the modem. The controller monitors both the GPS signal for current position and the modem for incoming location requests. Local event activation, such as push-to-talk (“PTT”) button or an emergency button, interrupt the monitoring and cause the controller to send the encoded current position, together with the unit identification and status, to the modem as a data packet. At the same time, the controller activates the connected radio transmitter to send out the signals from the modem.

The user tracking system 100 can be configured to have an emergency signal transmission feature. The system 100 can periodically send an emergency signal from the remote unit 102 and/or from the base unit 103. The base unit 103 can be configured to acknowledge the receipt of the emergency signal from the remote unit 102. Either of the remote unit 102 and/or the base unit 103 can be configured to be quieted. The system 100 also can be configured with one or more remote unit 102 and a single base unit 103, with each remote unit 102 including an identification code along with the location information, and the base unit 103 can use software that simultaneously displays the identification of each remote unit and a map location of each remote unit. The base unit 103 can be configured to query a particular individual remote unit 102 and obtain status and location data from that particular remote unit, and then display that information. The base unit 103 also can be configured to send commands to a particular remote unit 102 with or without sounding the remote unit's speaker. One such command is to kill or cut off the engine and/or other functions of an associated vehicle.

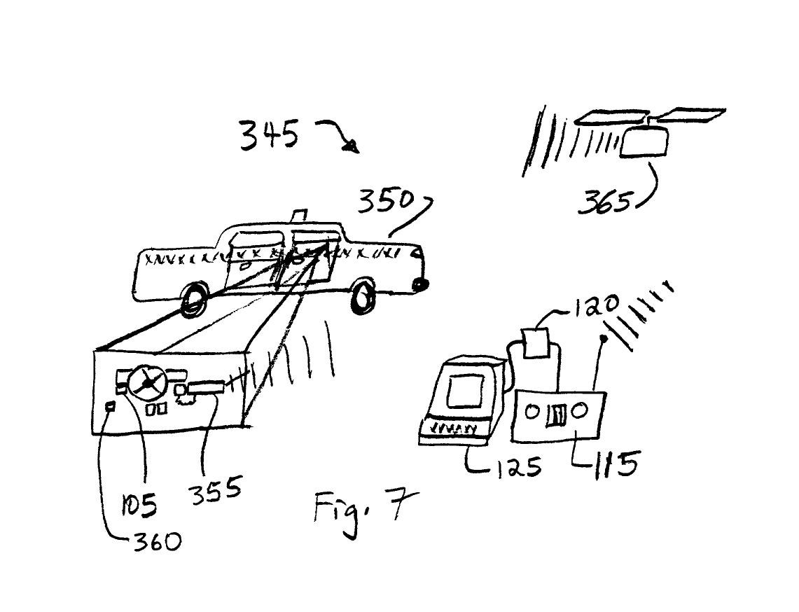

The user tracking system 100 can be configured to be used in any application that requires a first person or object to know the location of a second person or object. For example, referring to FIG. 7, the user tracking system can be implemented as an on-demand tracking and emergency location system 345. One such application is for a taxi cab company. Each taxi cab 350 has a remote radio 355, a remote tracking controller 105, and, optionally, a hidden foot switch 360. The remote tracking controller 105 is discreetly positioned, although exposed to a line of sight to more easily and reliably receive the transmission from a GPS satellite system 365. The controller also is electrically connected to the remote radio 355 and the hidden footswitch 360. In this manner, whenever the taxi cab operator operates the radio 355 or depresses the hidden footswitch 360, the controller 105 receives the GPS position data, converts the data, and then the radio transmits the data packet, all as described above. The operator at the base station receives the audio transmission, including the data packet, through the radio transceiver 115. The data packet then is decoded in the base controller tracker 120 and transmitted to the computer. The software in the computer takes that decoded data and uses it to determine the location of the taxi cab. The software also can take the data and using mapping software to show the location of the taxi cab 350 on labeled streets. With this result, the taxi cab company can direct the taxi cab to a location to pick up a call, provide directions to a taxi cab if it does not know how to get to a location from its current location, provide emergency assistance if the taxi cab has indicated, for example, that it is being car jacked or has a customer who is in an emergency medical condition.

In this application, the data packet can be configured to contain additional information that is pertinent to a taxi cab operation, such as whether the meter is on or off, whether the ignition is on or off, whether the doors are locked or unlocked, whether the trunk is open or closed, and whether the passenger is seated in the cab or not. For example, if the operator of the base unit 104 suspects that the taxi cab has been car jacked, the operator can use the base unit to transmit a signal to the remote unit 102 to take over control of certain operations of the car, such as turning off the ignition and/or causing the remote transceiver 110 to always and automatically transmit, which would cause the occupants' voices and the taxi cab's position to be continuously transmitted. The data packet transmitted between the base unit 103 and the remote unit 102 is reconfigured to accommodate the emergency situation. These features also can be used if the taxi cab is stolen. For example, if the base operator suspects that the car has been stolen, the operator can merely cause the base unit 103 to send a signal that causes the remote unit 102 to automatically transmit continuously to track the stolen taxi cab and shut the ignition off whenever the authorities are close to the car or at any other desired time.

The user tracking system 100 in this application also advantageously can be operated with only the initial capital cost and without monthly fees. This advantage results from the system being operated with the taxi cab company's existing radio system. Another cost savings results from the small size of the controller 105. Because the controller is small, it can be temporarily installed in a taxi cab at the beginning of the shift, removed at the end of the shift, and placed in a second taxi cab that is used in the subsequent shift. In this manner, the taxi cab company need only purchase the number of remote controller trackers 105 as there are taxi cabs operating at any one shift.

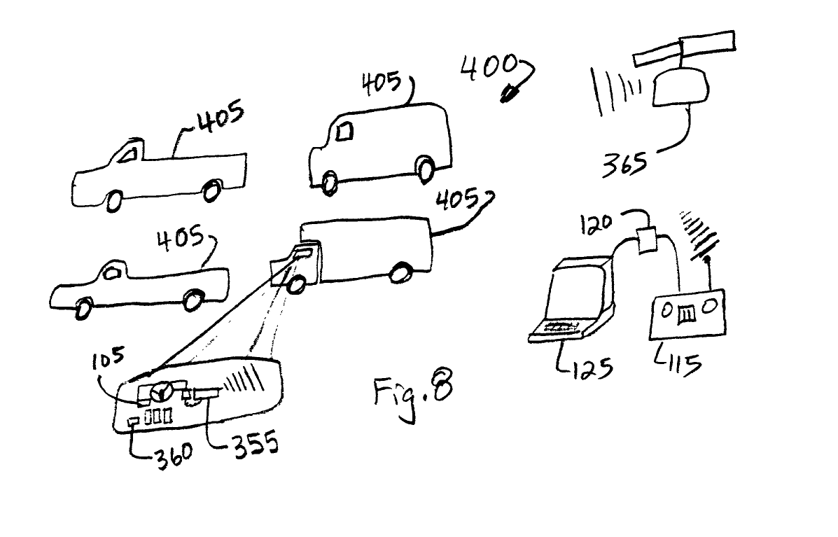

Referring to FIG. 8, the user tracking system 100 can be applied to a fleet management system 400. The fleet management system includes multiple vehicles 405. Each vehicle 405 is outfitted with the remote radio 355, the remote tracking controller 105, and, optionally, the hidden foot switch 360. The remote tracking controller 105 is positioned to be discreetly positioned although exposed to a line of sight to more easily and reliably receive the transmission from a GPS satellite system 365. The controller also is electrically connected to the remote radio 355 and the hidden footswitch 360. In this manner, whenever the vehicle driver operates the radio 355 or depresses the hidden footswitch 360, the controller 105 receives the GPS position data, converts the data, and then the radio transmits the data packet, all as described above. The operator at the base station receives the audio transmission, including the data packet, through the radio transceiver 115. The data packet then is decoded in the base controller tracker 120 and transmitted to the computer. The software in the computer takes that decoded data packet and uses it to determine the location of the particular vehicle. The software also uses the data packet and the mapping software to display the location of the vehicle 350 on labeled streets on a display. With this result, the fleet operator can direct the vehicle to a location to pick up, for example a package or make a delivery, provide directions to the vehicle operator if the operator does not know how to get to a location from its current location, or provide emergency assistance.

In this application, the data packet can be configured to contain additional information that is pertinent to a fleet manager, such as whether the vehicle is in operation, the operator is in the vehicle, the vehicle is in the midst of a delivery, the ignition is on or off, the doors are locked or unlocked, the passenger door is open or closed, or there is a passenger in the passenger seat, as well as fuel consumption, liquid levels in the vehicle, mileage, tire pressure, and speed. In addition, these items can be controlled from the base unit (i.e., turn on or off). For example, if the operator of the base unit 104 has an urgent pick up, the operator can use the base unit to transmit a signal to all of the remote units 102 to cause the occupants' voices and the vehicle's position to be continuously transmitted. The operator then can determine which vehicle is available for a pickup and which of those vehicles is closest to the location of the pickup. The data packet transmitted between the base unit 103 and the remote unit 102 also can be reconfigured to accommodate an emergency situation, such as if the vehicle is stolen. For example, if the base operator suspects that the vehicle has been stolen, the operator can cause the base unit 103 to send a signal that merely causes the remote unit 102 to automatically transmit continuously to track the stolen vehicle and shut the ignition off whenever the authorities are close to it or at any other desired time.

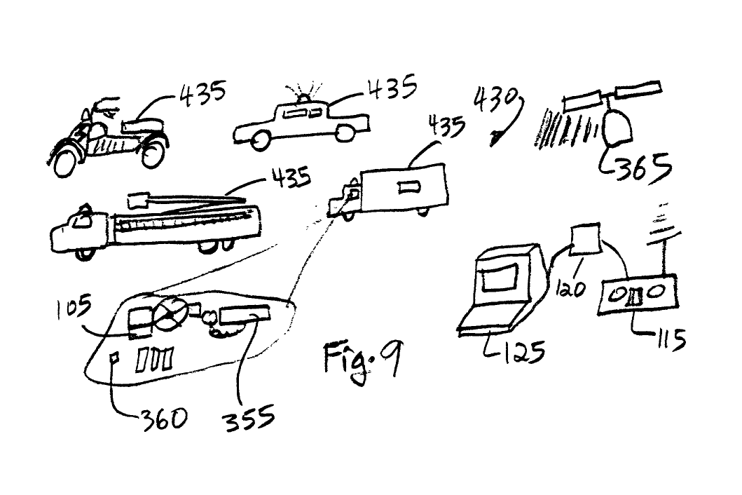

Referring to FIG. 9, the user tracking system 100 can be applied to a public safety vehicle environment 430, such as, for example, fire fighting vehicles, ambulances, police cars, and police motorcycles. The public safety vehicles 435 can be outfitted with the remote radio 355, the remote tracking controller 105, and, optionally, the hidden foot switch 360. The hidden foot switch is most likely to be useful when a criminal steals an officer's car in the midst of a criminal event. The user system 100 operates in the environment 430 in the same manner as described above with respect to the taxi cab system 345 and the fleet management system 400.

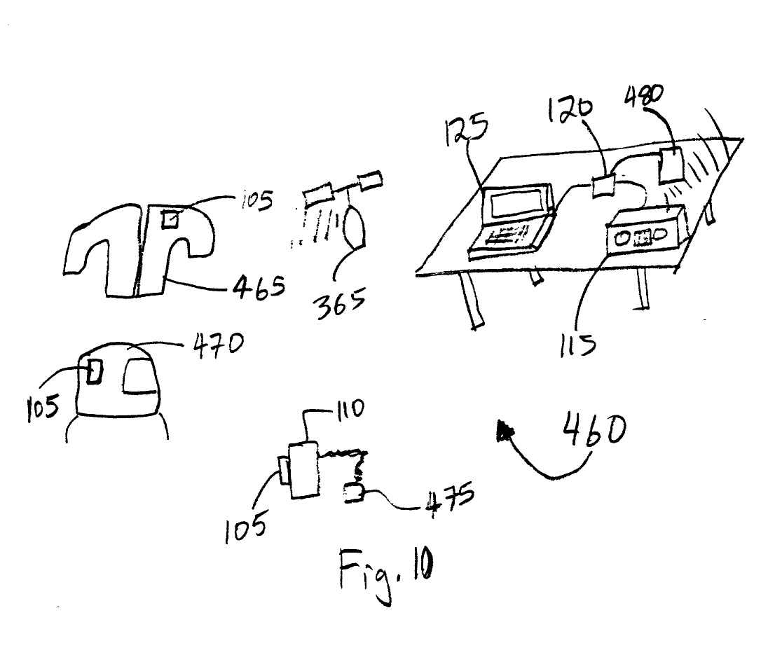

Referring to FIG. 10, the user tracking system 100 can be applied to a fire fighting battalion 460, such as a battalion that fights forest fires. The remote unit 102 can be used with a firefighter's jacket 465 by mounting the remote tracking controller 105 to the jacket and connected it to an radio transceiver 110, such as a walkie-talkie. The remote unit also can be used with a firefighter's helmet 470 by mounting the remote tracking controller 105 to the exterior of the helmet and connecting it to an internal or external radio transceiver. The remote tracking controller 105 also can be attached to a radio transceiver 110 having a microphone 475 and carried by the firefighter in the field. In any of these examples, the firefighter can be located in the field using the methods described above. Moreover, the base unit 103 can be configured to be field portable by including a portable power supply 480 to power the base controller tracker 120 and/or a lap top computer 125 and radio transceiver 114. In this manner, the system 460 can be used in the field in any location and the mapping software used to update location information of the firefighter for safety and firefighting purposes.

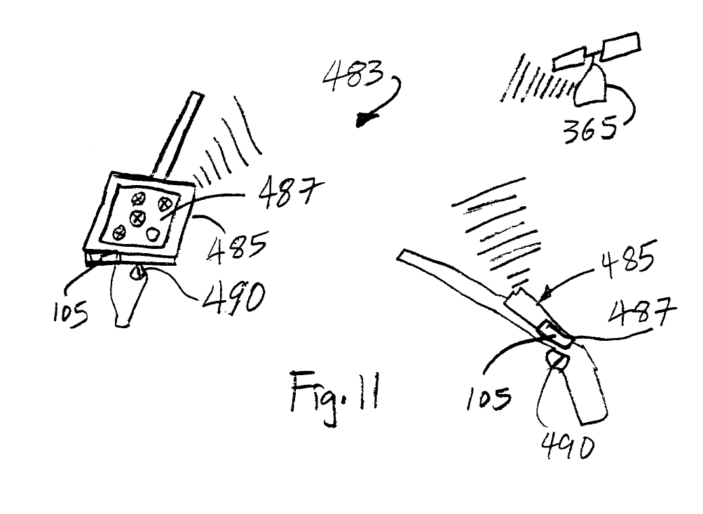

Referring to FIG. 11, the user tracking system 100 can be applied to a shooting game 483, such as paint ball, laser tag, or any other similar game. In this implementation, a game gun 485 includes a display 487, a built-in remote controller tracker 105, and a trigger 490. Activating the trigger causes an audio signal to be sent that includes the data packet described above, except that it is modified to include information relevant to the game, such as, for example, shots remaining or number of hits received, in addition to position and identification data. When the user activates the trigger 490, the other players will receive the data packet, the built-in remote controller tracker 105 will process the data packet, and internal software will take the resulting data and cause the other player's position to be displayed on the screen. In this manner, each time a player activates the trigger, for example, to shoot at another player, the other players will be informed of that player's position. The positions therefore will be continuously updated on each player's screen.

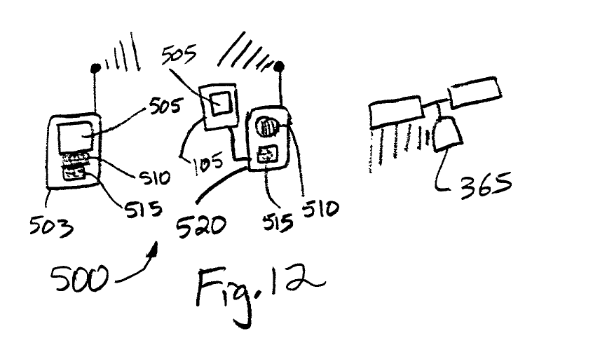

Referring to FIG. 12, the user tracking system 100 can be applied to a multi-person buddy system 500 used by, for example, hikers, cross-country skiers, and hunters. The system 500 includes a walkie-talkie 503 (or other radio) having a display 505, a speaker 510, and a microphone 515. The internal walkie-talkie circuitry also includes the circuitry of the remote controller tracker 105, namely, the GPS antenna, the GPS receiver, the data conversion controller, the modem, and the software implemented in the controller. The system 500 also includes a more conventional walkie-talkie 520 to which the remote controller tracker 105 is electrically connected. The remote controller tracker 105 also includes a display 505. In this system, when one walkie-talkie 503, for example, transmits audio, it also transmits the position data, as described above. The second walkie-talkie receives the signal and software in the remote controller tracker 105 and decodes and displays on the display 505 the position of the first walkie-talkie 503 relative to the second walkie-talkie 520. The positioning ability is based on using the received GPS position data from the first walkie-talkie and the receipt of GPS position data of the second walkie-talkie to determine the relative position of both walkie-talkies. Similarly, when the second walkie-talkie 520 transmits an audio signal, the first walkie-talkie 503 receives the signal and is able to display on the display 505 its position relative to the second walkie-talkie. The walkie-talkies 503 and 520 are implemented to have these capabilities by modifying the software and the transmitted data packets described above with respect to the user tracking system 100.

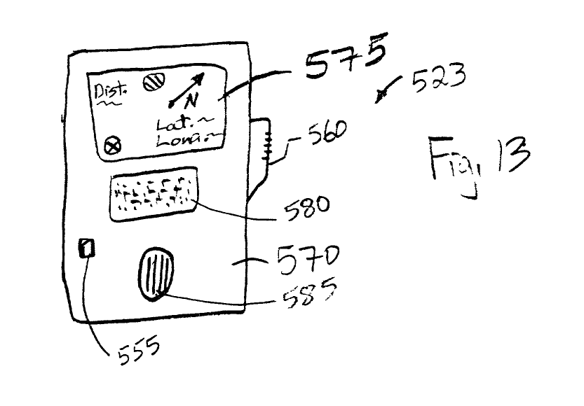

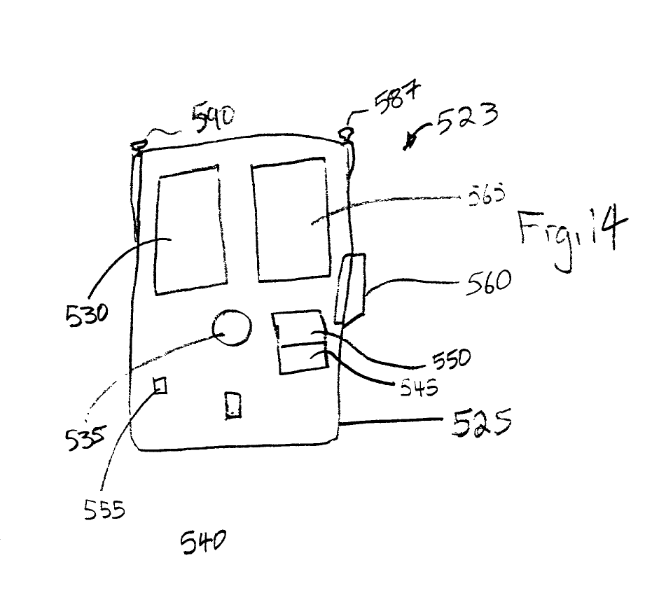

Referring to FIGS. 13 and 14, an improved, low-cost, portable walkie-talkie 523 can be fabricated within a conventionally-sized walkie-talkie enclosure 525. The internal components of the walkie-talkie 523 include a radio transceiver circuit board 530, a speaker 535, a microphone 540, a GPS antenna 545, a GPS receiver circuit board 550, a calibration button 555, a talk button 560, and a PCB 565. The PCB 565 is configured to include modem circuitry, power management system circuitry, and microprocessor circuitry. The PCB 565 and the radio transceiver circuit board 530 optionally can be combined as a single circuit board. The outer housing 570 includes a display 575, such as a flat-panel LCD display, a speaker cover 580, a microphone cover 585, the calibration button 555, and the talk button 560. The walkie-talkie 523 also includes a radio transceiver antenna 587 and an optional GPS antenna 590 that can be used in place of the internal GPS antenna 545.

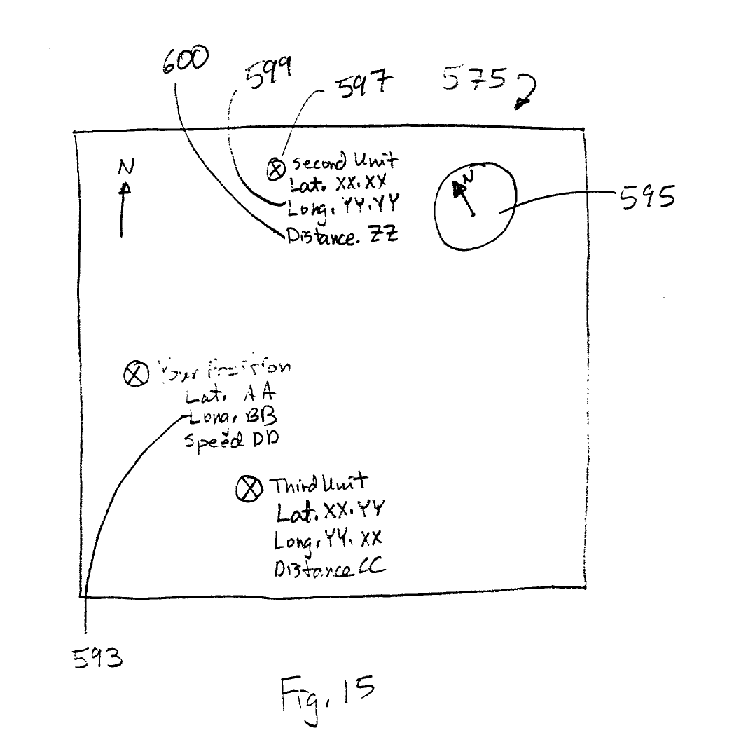

Referring also to FIG. 15, the microprocessor circuitry is programmed to provide data that help the operator locate himself relative to other walkie-talkie 523. For example, the operator can press the calibrate button 555 and have his position displayed graphically 590 and by latitude and longitude 593. The direction of true north also can be graphically displayed 595 on the LCD display 575. In the event that a second operator with a second walkie-talkie 523 transmits a signal, his position will be graphically displayed 597 relative to the first operator's position. In addition, the second operator's latitude, longitude, 599 and the distance 600 between the first and second operator also can be displayed on the first operator's display. Similarly, a third operator's position, distance, latitude, and longitude can be displayed relative to the first operator's. The same sequences also will occur and be displayed on the second and the third operator's displays.

The sequences and the data that are displayed are calculated by the microprocessor circuitry and do not rely upon an external computer or a mapping program to calculate this information. For example, the microprocessor can be programmed to take the position data of the first operator based on the GPS receiver, the position data of the second operator included in the data packet sent by the second operator, and determine and display the distance between the two locations. Similarly, the microprocessor can be configured to take the position data stored each time the operator presses the calibration button 555, calculate the distance and, using the difference in time between the two calibrations, calculate the average traveling speed of the first operator.

The user tracking system 100 in each of the above applications can be advantageously operated with only the initial capital cost and without monthly fees. This advantage results from the system being operated with any company's existing radio system. Another cost savings results from the small size of the controller 105. Because the controller is small, it can be temporarily installed in any vehicle or object at the beginning of the shift or operation, removed at the end of the shift or operation, and placed in a second vehicle or object that is used in the subsequent shift or operation. In this manner, the company need only purchase the number of remote controller trackers 105 as there are vehicles or people operating at any one shift.

A number of implementations of the user tracking system have been described. Nevertheless, it will be understood that various modifications may be made. Accordingly, other implementations are within the scope of the following claims.

What is claimed is:

1. A user tracking system comprising:
a first unit comprising a first radio transceiver and a first printed circuit board including microprocessor circuitry and modem circuitry; and
a second unit comprising a second radio transceiver and an enclosure enclosing a GPS antenna, a GPS receiver, and a second printed circuit board comprising circuitry for a microprocessor and circuitry for a modem.

2. The user tracking system of claim 1 wherein the enclosure has a volume that is less than approximately 5 cubic inches.

3. The user tracking system of claim 1 wherein the enclosure has a width that is less than two inches, a height that is less than two inches, and a depth that is less than one inch.

4. The user tracking system of claim 1 wherein the second printed circuit board has dimensions of between approximately 2 inches by 2 inches and 1.5 inches by 1.5 inches.

5. The user tracking system of claim 1 wherein the second printed circuit board further comprises power management circuitry.

6. The user tracking system of claim 1 wherein the second radio transceiver comprises radio transceiver circuitry and the enclosure farther includes the radio transceiver circuitry.

7. The user tracking system of claim 6 wherein the enclosure further includes an outer housing having a display screen.

8. The user tracking system of claim 1 wherein the modem circuitry is configured to convert data to a format that can be transmitted by the radio transceiver.

9. The user tracking system of claim 8 wherein the circuitry converts data using one or more of audio frequency shift keying, digital tone multiple frequency, or MSK techniques.

10. The user tracking system of claim 1 wherein the first unit further comprises a microprocessor and a display, and the microprocessor is configured to display a position of the second unit on the display.

11. The user tracking system of claim 9 wherein the software is configured to display a position of the second unit on one or more of a map display or an arrow display.

12. The user tracking system of claim 9 wherein the second unit is configured to transmit a signal that causes the first unit to activate a display procedure.

13. The user tracking system of claim 11 wherein the display procedure comprises one or more of a light indicator and a noise indicator.

14. The user tracking system of claim 1 wherein the second unit is in a vehicle and is configured to receive a signal from the first unit that causes the second unit to alter a vehicle function.

15. The user tracking system of claim 14 wherein the vehicle function comprises one or more of an ignition deactivation and a door lock or unlock.

16. The user tracking system of claim 1 wherein the second unit is in a vehicle and is configured to transmit a signal that is receivable by the first unit and contains one or more of an identification code, an emergency signal, position data, and vehicle operating information.

17. The user tracking system of claim 16 wherein the vehicle operating information comprises one or more of speed, fuel consumption, presence of a passenger, tire air pressure, and fare meter on or off.

18. A method of using a user tracking system, the method comprising:
providing a first unit comprising a first radio transceiver and a first printed circuit board comprising circuitry for a microprocessor and circuitry for a modem;
providing a second unit comprising a second radio transceiver and an enclosure enclosing a GPS antenna, a GPS receiver, and a second printed circuit board comprising circuitry for a microprocessor and circuitry for a modem;
creating a data packet;
sending a first transmission from the second unit, the first transmission including the data packet;
receiving the first transmission at the first unit; and
displaying location information about the second unit at the first unit.

19. The method of claim 18 wherein creating the data packet comprises:
receiving GPS data from the GPS receiver;
parsing and formatting the GPS data as a data packet in the microprocessor; and
converting the data packet in the modem to one or more audio tones.

20. The method of claim 18 wherein sending a first transmission comprises the second radio transceiver transmitting the audio tones.

21. The method of claim 18 wherein receiving the first transmission comprises the first radio transceiver receiving the first transmission.

22. The method of claim 19 wherein displaying location information about the second unit comprises:
converting the first transmission from one or more audio tones into a data packet;
extracting the location information from the data packet; and
using software to display the location information.

23. The method of claim 22 wherein displaying location information comprises displaying one or more of a position on a map and position coordinates.

24. The method of claim 18 further comprising:
sending a second transmission from the first unit;
receiving the second transmission at the second unit; and
causing the microprocessor circuitry in the second unit to take an action based on the received second transmission.

25. The method of claim 24 wherein the second transmission includes a data packet created in the microprocessor and converted in the modem to one or more audio tones.

26. The method of claim 24 wherein the action comprises one or more of continuously activating a transmission from the second unit and turning off a speaker of the second unit.

27. The method of claim 18 wherein the enclosure has a volume that is less than approximately 5 cubic inches.

28. The method of claim 18 wherein the enclosure has a width that is less than two inches, a height that is less than two inches, and a depth that is less than one inch.

29. The method of claim 1 wherein the second printed circuit board has dimensions of between approximately 2 inches by 2 inches and 1.5 inches by 1.5 inches.

30. The method of claim 18 wherein the second printed circuit board further comprises circuitry for a power management system.

31. A GPS transceiver comprising a printed circuit board including microprocessor circuitry, power management circuitry, and modem circuitry.

32. The GPS transceiver of claim 31 wherein the second printed circuit board has dimensions of between approximately 2 inches by 2 inches and 1.5 inches by 1.5 inches.

33. The GPS transceiver of claim 31 wherein the printed circuit board is positioned within an enclosure.

34. The GPS transceiver of claim 33 wherein the enclosure has a volume that is less than approximately 5 cubic inches.

35. The GPS transceiver of claim 33 wherein the enclosure has a width that is less than two inches, a height that is less than two inches, and a depth that is less than one inch.

36. The GPS transceiver of claim 33 wherein the enclosure further comprises radio transceiver circuitry.

37. The GPS transceiver of claim 36 further comprising a display screen, wherein the display screen is configured to display location information.

38. The GPS transceiver of claim 37 wherein the displayed location information is received by the GPS transceiver.

39. The GPS transceiver of claim 37 wherein the displayed location information is received by the radio transceiver circuitry.

40. The GPS transceiver of claim 38 wherein the information received by the GPS transceiver is converted to the displayed location information by the microprocessor circuitry.

41. The GPS transceiver of claim 38 further comprising a calibration button, wherein the calibration button causes the microprocessor circuitry to convert the information received by the GPS transceiver to display location information and to display the display location information on the display screen.

42. The GPS transceiver of claim 37 wherein the displayed location information is location information of a second GPS transceiver.

43. The GPS transceiver of claim 36 wherein further comprising a speaker, a microphone, and a push-to-talk button.
